(19) United States
(12) Patent Application Publication
(10) Pub. No.: US 2017/0134495 A1
(43) Pub. Date: May 11, 2017

(54) METHOD AND APPARATUS FOR SHARING COLLABORATIVELY EDITED DOCUMENT

(71) Applicant: INFRAWARE INC., Seoul (KR)

(72) Inventors: Jong-Deok JANG, Seoul (KR); SaeAm CHUNG, Seoul (KR)

(73) Assignee: INFRAWARE INC., Seoul (KR)

(21) Appl. No.: 15/027,931

(22) PCT Filed: Mar. 23, 2016
(86) PCT No.: PCT/KR2016/002926

§ 371 Date: Apr. 7, 2016

(30) Foreign Application Priority Data
Apr. 20, 2015 (KR) 10-2015-0055170
Mar. 11, 2016 (KR) 10-2016-0029623

(51) Int. Cl. H04L 29/08; H04L 29/06

(52) U.S. Cl. CPC H04L 67/1097; H04L 67/42; H04L 67/1095

(57) ABSTRACT

Disclosed is an apparatus for sharing a collaboratively edited document according to an exemplary embodiment of the present disclosure. The apparatus for sharing a collaboratively edited document may include: a command transferring server configured to receive two or more edition commands related to a collaboratively edited document from one or more clients included in a client group including two or more clients, and transmit the two or more edition commands to each of the clients included in the client group based on an order of the reception of the edition commands; and an engine-pool server configured to, when a predetermined condition is satisfied, update a seed document file related to the collaboratively edited document based on a command list collected based on the order of the reception of the received edition commands.

### TECHNICAL FIELD

The present disclosure relates to a method and an apparatus for sharing a collaboratively edited document, and more particularly, to a method and an apparatus for sharing a collaboratively edited document, by which a collaboratively edited document may be efficiently shared.

### BACKGROUND ART

Recently, according to the development of the communication technology, various services have been provided through the Internet. Particularly, large files are moved and the large amount of data is transceived through the Internet. Accordingly, a technology for sharing various files anytime and anywhere through the Internet has also been developed.

As described above, a service for enabling users using terminals to store data or files in a virtual storage place, and to exchange and share the data or the files through the virtual storage place based on various communication technologies (for example, the Internet) is referred to as the cloud service. A user is capable of freely using data or a file through the cloud service. Particularly, a user is capable of downloading or uploading data or a file without a restriction of time and a space through the cloud service, and is also capable of sharing the data or the file with other users.

The cloud service is provided based on a sharing server which is a storage place, in which data or a file is stored and shared. Particularly, the users are capable of storing and sharing document files through the sharing server, and are capable of editing the document file through their own terminals.

However, when the users edit the shared document shared in their own terminals, the sharing server includes an engine for receiving edited contents input from each of the terminals of the users, reflecting the edited contents to the shared document, and updating the shared document. Accordingly, according to an increase in the number of terminals sharing the shared document, the sharing server requires the larger number of engines required for reflecting the contents editing the shared document, and when the larger number of engines are used, a load of data, which the sharing server needs to process, is also increased. That is, according to the increase in the number of terminals sharing the shared document, a load of the sharing server for reflecting the edited contents to the shared document is increased, performance of the sharing server is degraded, and a quality of the cloud service is degraded.

Accordingly, in order to decrease a load of a server providing a shared document for sharing and editing and efficiently share and edit the shared document, a need for providing a method of sharing a shared document by using a plurality of servers is increased.

### RELATED TECHNICAL DOCUMENT

Document Collaboration Method (Korean Patent Application Laid-Open No. 10-2014-0028040)

### DISCLOSURE

### Technical Problem

The present disclosure has been made in an effort to provide a method and an apparatus for sharing a collaboratively edited document, by which a shared document (hereinafter, referred to as a “collaboratively edited document”) may be rapidly edited so that a plurality of clients may edit the shared document by using a small amount of resources.

The present disclosure has also been made in an effort to provide a method and an apparatus for sharing a collaboratively edited document, which are capable of rapidly providing an updated collaboratively edited document to a new added client when the new client shares the collaboratively edited document during the editing of the collaboratively edited document.

Objects of the present disclosure are not limited to the objects described above, and other objects that are not described will be clearly understood by a person skilled in the art from the description below.

### Technical Solution

In order to solve the aforementioned objects, according to an exemplary embodiment of the present disclosure, an apparatus for sharing a collaboratively edited document is disclosed. The apparatus may include: a command transferring server configured to receive two or more edition commands related to a collaboratively edited document from one or more clients included in a client group including two or more clients, and transmit the two or more edition commands to each of the clients included in the client group based on an order of the reception of the edition commands; and an engine-pool server configured to, when a predetermined condition is satisfied, update a seed document file related to the collaboratively edited document based on a command list collected based on the order of the reception of the received edition commands.

Alternatively, the apparatus may further include a command storing server configured to generate the command list collected based on the order of the reception of the received edition commands, and transmit the command list to the engine-pool server when the predetermined condition is satisfied.

Alternatively, the predetermined condition may include a case where the edition command is not received from the one or more clients for a predetermined time, a case where the edition command larger than a predetermined threshold value is accumulated in the command storing server, or a case where a connection termination of one or more clients is detected.

Alternatively, the apparatus may further include a seed document server configured to store a seed document file generated based on a document file uploaded on a sharing server, and transmit the seed document file to one or more clients included in the client group including two or more clients.

Alternatively, the engine-pool server may transmit an updated seed document file to the seed document server, and the seed document server may store the updated seed document file together with the seed document file.

Alternatively, when an additional client, which is not included in the client group, is connected to the seed document server so as to collaboratively edit the document file, the seed document server may transmit the updated seed document file to the additional client, the command storing server may transmit an additional edition command, which is stored after the command list is transmitted to the engine-pool server, to the command transferring server, and the command transferring server may transmit the additional edition command to the additional client.

Alternatively, the apparatus may further include a short cut file server configured to generate a short cut file based on the document file when a sharing server receives a sharing signal indicating a desire to share the document file with the client included in the client group or an additional client which is not included in the client group.

Alternatively, the short cut file may include information on a location, in which the seed document file is stored, and the seed document server may enable each of the one or more clients included in the client group or an additional client to receive the seed document file through the short cut file.

According to another exemplary embodiment of the present disclosure, a method of sharing a collaboratively edited document, which is performed by an apparatus of sharing a collaboratively edited document, is disclosed. The method may include: transmitting, by a seed document server, a seed document file to one or more clients included in a client group including two or more clients; receiving, by a command transferring server, two or more edition commands related to a collaboratively edited document from the one or more clients; transmitting, by the command transferring server, the two or more edition commands to each of the clients included in the client group based on an order of the reception of the two or more edition commands; and when a predetermined condition is satisfied, updating, by an engine-pool server, a seed document file related to the collaboratively edited document based on a command list collected based on the order of the reception of the received edition commands, and generating an updated seed document file.

Alternatively, the method may further include: generating, by the command storing server, the command list collected based on the order of the reception of the received edition commands; and transmitting, by the command storing server, the command list to the engine-pool server when the predetermined condition is satisfied.

Alternatively, the method may further include: when an additional client, which is not included in the client group, is connected so as to collaboratively edit the document file, transmitting, by the seed document server, the updated seed document file to the additional client; and transmitting, by the command transferring server, an additional edition command, which is stored after the updated seed document file is generated, to the additional client.

Alternatively, the method may further include transmitting, by the seed document server, the seed document file to each of the one or more clients included in the client group or an additional client connected through a short cut file generated based on the document file.

According to another exemplary embodiment of the present disclosure, a computer-readable recording medium, which is executable in a computer and includes a plurality of commands executed by one or more processors, is disclosed. The computer-readable recording medium may include: a command for transmitting, by a seed document server, a seed document file to one or more clients included in a client group including two or more clients; a command for receiving, by a command transferring server, two or more edition commands related to a collaboratively edited document from the one or more clients; a command for transmitting, by the command transferring server, the two or more edition commands to each of the clients included in the client group based on an order of the reception of the two or more edition commands; and a command for updating, by an engine-pool server, a seed document file related to the collaboratively edited document based on a command list collected based on the order of the reception of the received edition commands, and generating an updated seed document file, when a predetermined condition is satisfied.

According to another exemplary embodiment of the present disclosure, a method of sharing a collaboratively edited document, which is performed by a client device, is disclosed. The method may include: transmitting an edition command editing a collaboratively edited document to a command transferring server so that the edition command is transferred to one or more other clients included in a client group including two or more clients through the command transferring server; receiving an edition command editing a collaboratively edited document, which is transmitted from the command transferring server and represents an edition for the collaboratively edited document performed by another client; and generating an updated collaboratively edited document based on the edition command editing the collaboratively edited document received from the one or more other clients and the collaboratively edited document.

According to another exemplary embodiment of the present disclosure, a method of sharing a collaboratively edited document, which is performed by a client device, is disclosed. The method may include: transmitting a request for a collaborative edition for a collaboratively edited document, which is currently edited by a client group including two or more clients, to a seed document server; receiving an updated seed document file generated based on one or more edition commands editing a collaboratively edited document, which are received from the client included in the client group before an engine-pool server generates the updated seed document file, and a seed document, from the seed document server; receiving one or more additional edition commands editing the collaboratively edited document, which are received after the updated seed document file is generated from the client included in the client group, from a command storing server; and generating an updated collaboratively edited document based on the updated seed document file received from the seed document server and the additional edition command received from the command storing server.

### Advantageous Effects

According to the exemplary embodiments of the present disclosure, it is possible to provide the method and the apparatus for sharing a collaboratively edited document, which are capable of rapidly editing a shared document so that a plurality of clients edits the document by using the small amount of resources.

According to the exemplary embodiments of the present disclosure, it is possible to provide the method and the apparatus for sharing a collaboratively edited document, which are capable of rapidly providing an updated collaboratively edited document to a new additional client when the new client shares the collaboratively edited document during the editing of the collaboratively edited document.

The effects according to the present disclosure are not limited to the contents exemplified above, and more various effects are included in the present specification.

### DESCRIPTION OF DRAWINGS

FIG. 1 is a diagram illustrating a relation among an apparatus for sharing a collaboratively edited document, a sharing server, a short cut file server, and a client according to an exemplary embodiment of the present disclosure.

FIG. 2 is a flowchart illustrating a procedure for sharing a collaboratively edited document file according to a method for sharing a collaboratively edited document according to an exemplary embodiment of the present disclosure.

FIG. 3 is a diagram illustrating a relation between a configuration of the apparatus for sharing the collaboratively edited document and clients according to the exemplary embodiment of the present disclosure.

FIGS. 4A and 4B are diagrams illustrating an engine and an example of an output screen of a client sharing a collaboratively edited document by the method for sharing the collaboratively edited document according to the exemplary embodiment of the present disclosure.

FIG. 5 is a diagram illustrating a relation between a configuration of an apparatus for sharing a collaboratively edited document and a client according to another exemplary embodiment of the present disclosure.

FIGS. 6A and 6B are diagrams illustrating an example of an output screen of a client sharing a collaboratively edited document by the method for sharing the collaboratively edited document according to another exemplary embodiment of the present disclosure.

FIG. 7 is a diagram illustrating a relation between a configuration of an apparatus for sharing a collaboratively edited document and a client according to still another exemplary embodiment of the present disclosure.

FIGS. 8A and 8B are diagrams illustrating an engine and an example of an output screen of a client sharing a collaboratively edited document by the method for sharing the collaboratively edited document according to the still another exemplary embodiment of the present disclosure.

FIG. 9 is a diagram illustrating a schematic configuration of an apparatus for sharing a collaborative document, and a relation between the apparatus for sharing the collaborative document and a sharing server, and a relation between the apparatus for sharing the collaborative document and a document editing terminal according to the second exemplary embodiment of the present disclosure.

FIG. 10 is a flowchart illustrating a procedure for updating a collaborative document file according to a method for sharing a collaborative document by using dualized servers according to the second exemplary embodiment of the present disclosure.

FIG. 11 is a diagram illustrating an example of a method of sharing a collaborative document file, and receiving and storing an edition command according to the method for sharing the collaborative document by using the dualized servers according to the second exemplary embodiment of the present disclosure.

FIG. 12 is a diagram illustrating an example of a method of sharing a collaborative document with an additional document editing terminal according to the method for sharing the collaborative document by using the dualized servers according to the second exemplary embodiment of the present disclosure.

FIG. 13 is a diagram illustrating an example of an update condition selectable in the method for sharing the collaborative document by using the dualized servers according to the second exemplary embodiment of the present disclosure.

### BEST MODE

Advantages and features of the present disclosure and methods accomplishing the advantages and features will become apparent from the following detailed description of exemplary embodiments with reference to the accompanying drawings. However, the present disclosure is not limited to exemplary embodiments disclosed herein but will be implemented in various forms, and the exemplary embodiments are provided so that the present disclosure is completely disclosed, and a person of ordinary skilled in the art can fully understand the scope of the present disclosure, and the present disclosure will be defined only by the scope of the appended claims.

Shapes, sizes, ratios, angles, the number, and the like illustrated in the drawings for describing the exemplary embodiments of the present disclosure are illustrative, and the present disclosure is not limited to the illustrated matters. Further, in the description of the present disclosure, a detailed explanation of related publicly known arts is omitted when it is determined that the detailed explanation unnecessarily makes the subject matter of the present disclosure obscure. When terms “include”, “have”, “implement” and the like mentioned in the present specification are used, other components may be added unless a term “only” is used. In a case where the constituent element is expressed in a singular form, the singular form includes a plural form unless explicitly described.

In the interpretation of constituent elements, the constituent elements are interpreted to include error ranges even though an explicit description is not separately provided.

Although “a first . . . ”, a second . . . ”, and the like, are used for describing various constituent elements, the constituent elements are not limited by the terms. The terms are simply used for discriminating one constituent element from another constituent element. Accordingly, a first constituent element mentioned below may be a second constituent element within the technical spirit of the present disclosure.

Unless specified otherwise, like reference numerals indicate like constituent elements throughout the specification.

Respective characteristics of several exemplary embodiments of the present disclosure may be partially or entirely coupled or combined, and technically and variously connected and driven enough for those skilled in the art to fully understand, and respective exemplary embodiments may be independently carried out, and implemented together according to an associated relation.

Hereinafter, terms used in the present specification will be defined.

A document editing terminal in the present specification is a terminal capable of editing an electronic document file, and means a terminal capable of sharing an electronic document file stored in a sharing server, such as a cloud server, and editing contents, setting, and the like of the electronic document file.

A collaboratively edited document in the present specification is a collaboratively written document shared by a plurality of document editing terminals, and means an electronic document shared by the document editing terminals. The collaboratively edited document may mean an electronic document stored in a cloud server which the document editing terminals access for sharing the electronic document.

A collaboratively edited document file in the present specification means a collaboratively edited document itself, which may be shared and edited through a plurality of document editing terminals, or a path through which a plurality of document editing terminals may access a collaborative document. For example, the collaboratively edited document file may be a collaborative document itself, which is transmitted from a sharing server, such as a cloud server, and is temporarily stored in a collaborative document sharing apparatus, or a link, through which a document editing terminal may access a collaborative document.

A seed document file in the present specification is a file for editing corresponding to a document file (hereinafter, a collaboratively edited document file) which clients are desired to collaboratively edit, and means a document file for editing shared by the clients before an edition command is applied. The seed document file may be stored in an apparatus for sharing a collaboratively edited document, and when a client requests a share of the document file, the seed document file may be transmitted to the client.

An edition command in the present specification is a command for editing a document shared by clients, and includes various commands input into a collaboratively edited document. For example, the edition command may include a deletion command for detecting at least some contents of a collaboratively edited document, an addition command, a command for changing a form of a document, and the like, an insertion command for inserting an object, such as a picture, and the like. An edition command input by a predetermined client may be transmitted to an apparatus for sharing a collaboratively edited document, and then may be transmitted to a client connected to the apparatus for sharing the collaboratively edited document.

A command list in the present specification is a list of stored edition commands obtained by receiving edition commands according to a predetermined rule. For example, the command list may be a list, in which edition commands received until a predetermined condition is satisfied is stored.

An additional client in the present specification means a client connected to an apparatus for sharing a collaboratively edited document after at least one edition command for a document file is input into the apparatus for sharing the collaboratively edited document. That is, the additional client means a client connected to an apparatus for sharing a collaboratively edited document after a client, which is already connected to the apparatus for sharing the collaboratively edited document, edits a seed document file. That is, the additional client may mean a client which is not included in a client group including clients connected to an apparatus for sharing a collaboratively edited document.

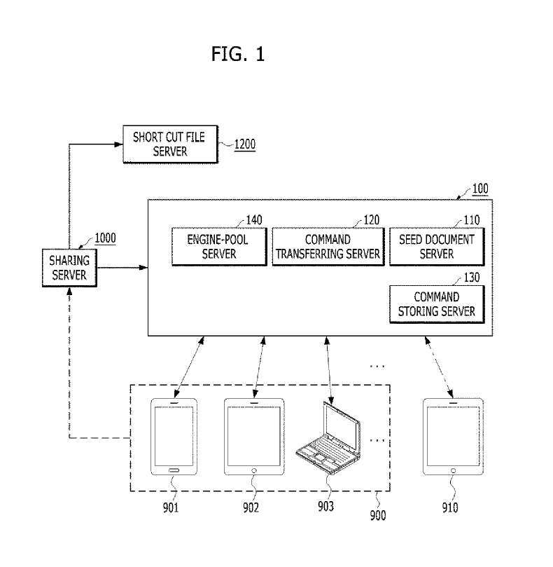

FIG. 1 is a diagram illustrating a relation among an apparatus for sharing a collaboratively edited document, a sharing server, a short cut file server, and a client according to an exemplary embodiment of the present disclosure.

Referring to FIG. 1, an apparatus 100 for sharing a collaboratively edited document (hereinafter, a collaboratively edited document sharing apparatus) includes a seed document server 110, a command transferring server 120, a command storing server 130, and an engine-pool server 140. The collaboratively edited document sharing apparatus 100 may be connected to be capable of communicating with one or more clients 900 and an additional client 910. Further, the collaboratively edited document sharing apparatus 100 may also be connected to be capable of communicating with a sharing server 1000 and a short cut file server 1200. One or more clients connected to the collaboratively edited document sharing apparatus 100 may configure a client group 900. The client group 900 may mean a group including at least two clients related with a collaboratively edited document, but is not limited thereto. For example, even when clients included in the client group 900 leave the client group 900 and only one client is included in the client group 900, the one client may also be referred to as the client group 900. Even when the ground group 900 is generated and only one client is designated, the one client may also be referred to as the client group 900. The client group 900 may be formed of the entirety or a part of the clients which are accessible to the same collaboratively edited document. The number of documents collaboratively edited by the client group 900 may be one or two or more. When the number of documents collaboratively edited by the client group 900 is two or more, the plurality of documents may have a combination of the same type (for example, spread sheet documents) or a combination of different types (for example, a combination of spread sheet document and a text document). The client belonging to one client group 900 may also be included in another client group. One or more client groups 900 may be generated for one collaboratively edited document. The client group 900 may include clients which share a predetermined event or need to share edition commands by a predetermined reason. Hereinafter, in the specification, “one or more clients” may mean one or more clients included in the client group 900, or may be used for describing a collective operation of the entire client group 900.

The seed document server 110 may store a seed document file and an updated seed document file, and provide the seed document file to the engine-pool server 140. Further, the seed document server 110 may store a seed document file generated based on a document file uploaded to the sharing server 1000, and transmit the seed document file to one or more clients included in a client group including two or more clients.

The command transferring server 120 receives an edition command from the one or more clients 900, and transmits the received edition command to the one or more clients 900 again. The command transferring server 120 may receive two or more edition commands related to a collaboratively edited document from one or more clients included in the client group 900 including two or more clients, and transmit the two or more edition commands to each of the clients included in the client group based on an order of the reception. For example, the command transferring server 120 transmits the edition command received from a second client 902 to all of the one or more clients 900. Further, the command transferring server 120 transmits the edition command received from the one or more clients 900 to the command storing server 130.

The command storing server 130 stores edition commands transmitted from the command transferring server 120. Particularly, the command storing server 130 may store edition commands according to an order of the transmission of the edition commands by the command storing server 130. Here, the order of the transmission of the edition commands by the command transferring server 120 may be the same as the order of the reception of the edition commands by the command transferring server 120. Further, the command storing server 130 may store the edition commands based on the order of the reception of the edition commands and generate a command list, and transmit the command list to the engine-pool server 140 according to a predetermined condition. The command storing server 130 may generate the command list collected based on the order of the reception of the edition commands received by the command transferring server 120, and transmit the generated command list to the engine-pool server 140 when a predetermined condition is satisfied. The predetermined condition may include a case where an edition command is not received from the one or more clients for a predetermined time, a case where an edition command is accumulated in the command storing server to be larger than a predetermined threshold value, or a case where a connection termination of one or more clients is detected. The command storing server 130 may also be a different module different of the server, which is physically the same as the command transferring server 120, and may also be a physically divided server from the command transferring server 120.

The engine-pool server 140 receives a seed document file from the seed document server 110, receives a command list from the command storing server 130, and generates an updated seed document file based on the seed document file and the command list. For example, the engine-pool server 140 may generate an updated seed document file by combining a seed document file with an edition command included in the command list. Further, the engine-pool server 140 may include an engine generating an updated collaboratively edited document file based on the seed document file and the edition command or the updated seed document file and an additional edition command. When a predetermined condition is satisfied, the engine-pool server 140 may update the seed document file related to the collaboratively edited document based on the command list collected based on the order of the reception of the received edition commands. Further, the engine-pool server 140 transmits the updated seed document file to the seed document server 110 again.

Referring to FIG. 1, the one or more clients 900 include a first client 901, the second client 902, and a third client 903. Although it is illustrated in FIG. 1 that the one or more clients 900 include three clients, the number of clients included in the one or more clients 900 is not limited thereto. The first to third clients may configure the client group 900.

Referring to FIG. 1, the one or more clients 900 may update a document file on the sharing server 1000. Particularly, one predetermined client, for example, the first client 901, among the one or more clients 900, may upload a document file desired to be shared on the sharing server 1000. Hereinafter, a method of sharing a collaboratively edited document will be described based on a case where the first client 901 uploads the document file on the sharing server 1000.

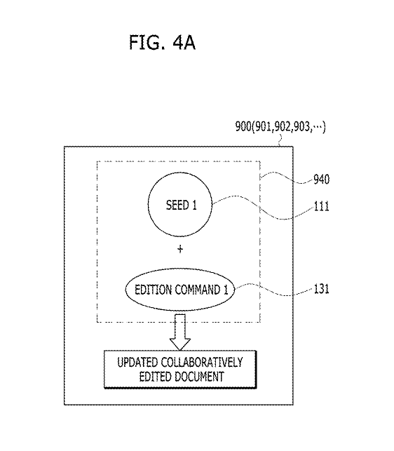

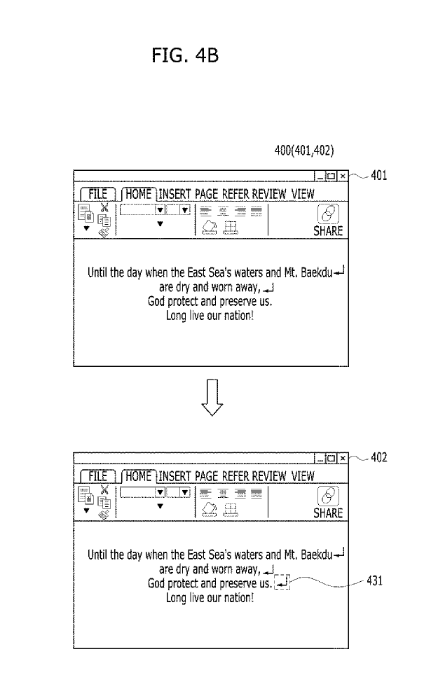

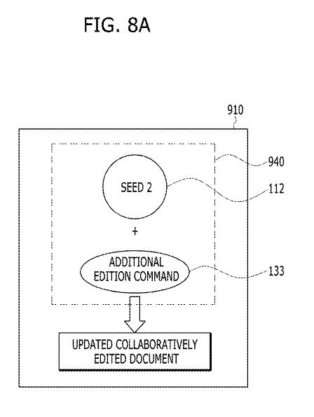

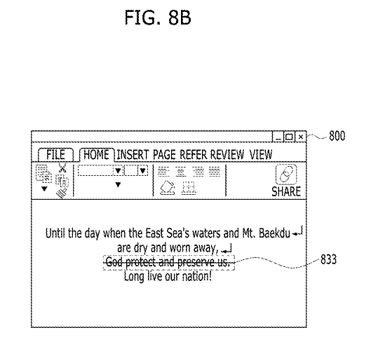

Further, each of the one or more clients 900 includes an engine generating an updated collaboratively edited document file based on a seed document file and an edition command or an updated seed document file and an additional edition command. A particular function of the engine included in each of the one or more clients 900 will be described below with reference to FIGS. 4 and 8.

Referring to FIG. 1, the sharing server 1000 may provide information about the document file to the collaboratively edited document sharing apparatus 100. For example, the sharing server 1000 may copy the document file and provide a seed document file to the collaboratively edited document sharing apparatus 100.

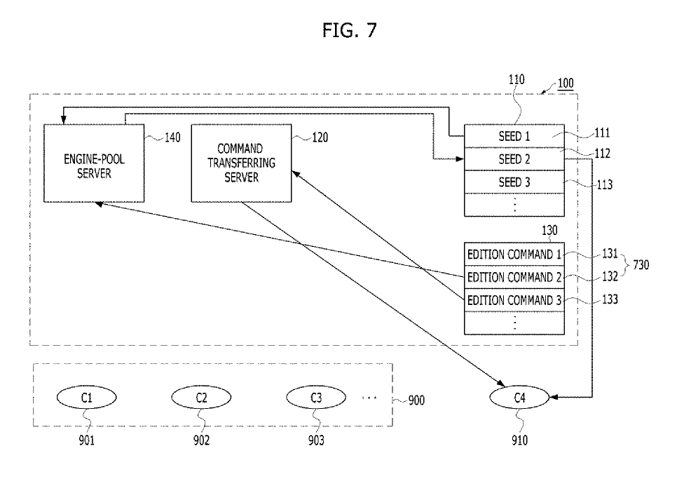

Referring to FIG. 1, the short cut file server 1200 is connected to be capable of communicating with the sharing server 1000. Particularly, the short cut file server 1200 generates a short cut file based on the file document uploaded on the sharing server 1000. For example, when the sharing server 1000 receives a sharing signal, which represents that the first client 901 desires to share the document file with other clients, which is included in the client group 900, or an additional client 910, which is not included in the client group 900, from the first client 901, the short cut file server 1200 generates a short cut file based on the uploaded document file. A particular description of the short cut file will be described below with reference to FIGS. 7 and 8.

Accordingly, the collaboratively edited document sharing apparatus 100 including the command transferring server 120 and the engine-pool server 140, which dualizes the transfer of the command and the update of the seed document file, may improve waste of resources of the server and deterioration of an update speed and performance of the collaborative document file, which are generated when the collaborative document file is updated whenever the edition command is received through one server.

The collaboratively edited document sharing apparatus 100 according to the exemplary embodiment of the present disclosure may separate the function of transmitting the edition command received from the client to another client and the function of combining the edition command with the collaboratively edited document, so that it is not necessary to increase the number of engines according to an increase in the number of clients, thereby preventing the amount of resource required from being sharply increased and decreasing a burden of the server.

Each configuration of the collaboratively edited document sharing apparatus 100 is separately illustrated for convenience of the description, and the configurations may be implemented by one configuration or one configuration may be divided into two or more configurations according to an implementation method.

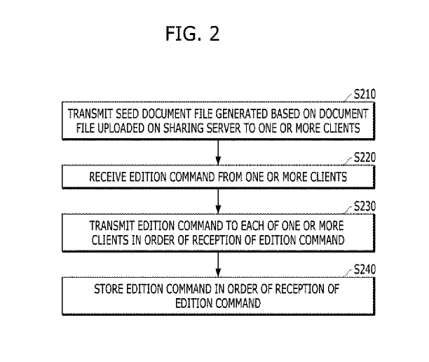

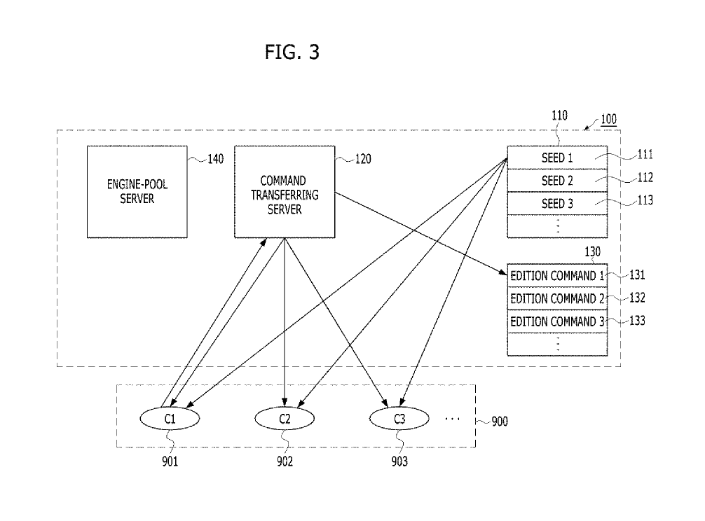

FIG. 2 is a flowchart illustrating a procedure for sharing a collaboratively edited document file according to the method for sharing the collaboratively edited document according to the exemplary embodiment of the present disclosure. FIG. 3 is a diagram illustrating a relation between the configuration of the apparatus for sharing the collaboratively edited document and the clients according to an exemplary embodiment of the present disclosure. For convenience of the description, the description is given with reference to FIG. 1.

The method for sharing the collaboratively edited document according to the present disclosure is initiated by transmitting, by the seed document server 110, a seed document file generated based on a document file uploaded on the sharing server 1000 to the one or more clients 900 (S210).

Referring to FIG. 3, the seed document server 110 stores the seed document file, and transmits the seed document file to a client, which is connected to the collaboratively edited document sharing apparatus 100 and requests a collaborative edition. Particularly, the seed document server 110 may store a plurality of seed document files. For example, when the seed document file is generated by the request of the client, the seed document server 110 stores the generated seed document file.

Further, when an updated seed document file is generated based on the seed document file and a command list, the seed document server 110 may also store the updated seed document file. For example, when a first seed document file 111 is generated by the request of the client, the first seed document file 111 is stored in the seed document server 110, and when a second seed document file that is an updated seed document file is generated based on the first seed document file 111 and a command list, the second seed document file is also stored in the seed document server 110. Accordingly, the seed document server 110 may store one or more seed document files.

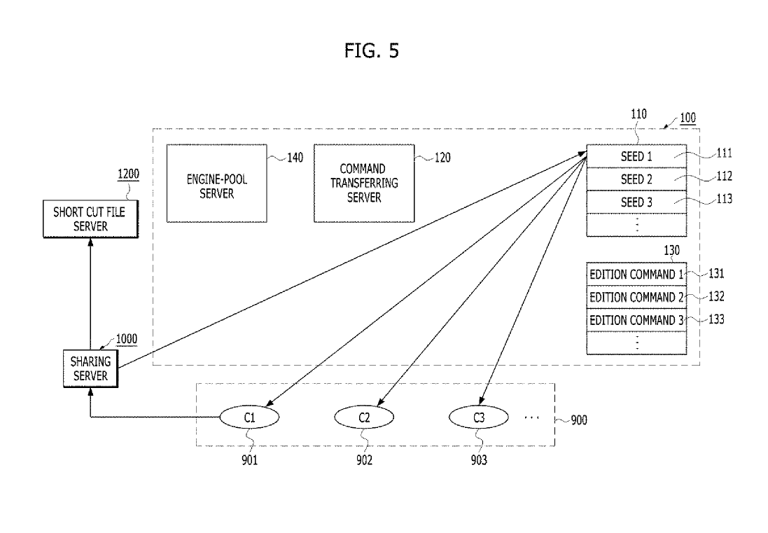

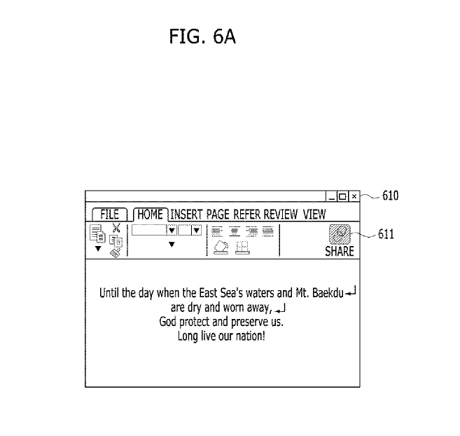

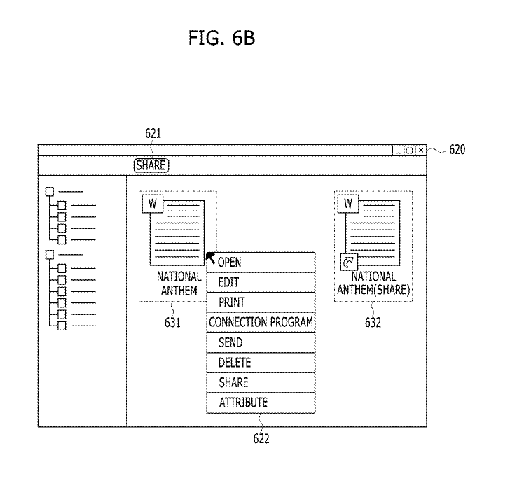

Referring to FIG. 3, the seed document server 110 may transmit the stored seed document file to the one or more clients 900. Particularly, when the one or more clients 900 desire to share the document file, the seed document server 110 may transmit the seed document file corresponding to the sharing requested document file to the client. A particular process of transmitting the seed document file to the client by the seed document server 110 will be described below with reference to FIGS. 5 and 6.

Further, the seed document server 110 may transmit the updated seed document file to the additional client 910, which requests the collaborative edition and is additionally connected to the collaboratively edited document sharing apparatus 100, in addition to the client connected to the collaboratively edited document sharing apparatus 100. A particular process of transmitting the updated seed document to the additional client 910 will be described below with reference to FIGS. 7 and 8.

Next, the command transferring server 120 receives an edition command from the one or more clients 900 (S220). Next, the command transferring server 120 transmits the edition command to each of the one or more clients 900 in accordance with an order of the reception of the edition command (S230).

Referring to FIG. 3, when the command transferring server 120 receives the edition command from any one of the one or more clients 900, the command transferring server 120 immediately transmits the received edition command to each of all of the clients included the one or more clients 900. For example, when the first client 901 inputs a first edition command 131, the command transferring server 120 receives the first edition command 131 and transmits the received first edition command 131 to each of the one or more clients 900. Further, when the first client 901 sequentially inputs a second edition command 132 and a third edition command 133, the command transferring server 120 first transmits the second edition command 132 to each of the one or more clients 900 in accordance with the order of the reception of the edition command, and then transmits the third edition command 133 to each of the one or more clients 900. FIG. 3 illustrates that the edition command is transferred from the first client 901, but the edition command is not limited thereto, and may be randomly transmitted from each of the one or more clients 900.

Further, the command transferring server 120 transmits the edition command to the command storing server 130 according to the order of the reception. For example, when the command transferring server 120 receives the edition commands based on the order of the first edition command 131, the second edition command 132, and the third edition command 133 from each of the one or more clients 900, the command transferring server 120 also transmits the edition commands to the command storing server 130 based on the order of the first edition command 131, the second edition command 132, and the third edition command 133.

Accordingly, each of the one or more clients 900 may receive the edition commands through the command transferring server 120 in real time, and generate the updated collaboratively edited document in real time by applying the edition commands to the seed document file of each of the one or more clients 900. Each of the one or more clients 900 may generate the updated collaboratively edited document by transmitting the edition command editing the collaboratively edited document to the command transferring server so that the edition command is transmitted to one or more other clients included in the client group including two or more clients through the command transferring server, receiving an edition command editing the collaboratively edited document, which is transmitted from the command transferring server and represents the edition of the collaboratively edited document performed by other clients, and generating the updated collaboratively edited document based on the edition commands editing the collaboratively edited document received from the one or more other clients and the collaboratively edited document. A particular process of generating the updated collaboratively edited document by each of the one or more clients 900 will be descried below with reference to FIG. 4.

Next, the command storing server 130 stores the edition command in accordance with the order of the reception of the edition command (S240).

Here, the operation of transmitting, by the command transferring server 120, the edition command to the command storing server 130 may be performed simultaneously with the operation of transmitting, by the command transferring server 120, the edition command to the one or more clients 900.

Further, the command storing server 130 may generate a command list based on the order of the reception of the edition command and store the edition command. Further, the command storing server 130 may transmit the edition command stored under a predetermined condition or the command list to the engine-pool server 140. A particular transmission relation of the edition command and the command list between the command storing server 130 and the engine-pool server 140 will be described below with reference to FIGS. 7 and 8.

Accordingly, the collaboratively edited document sharing apparatus 100 immediately transmits the edition command to the one or more clients 900 through the command transferring server 120, so that it is possible to efficiently collaboratively edit and update the document file by a small processing load and by using only the small amount of resources. Further, the collaboratively edited document sharing apparatus 100 stores the received edition commands in the command storing server 130 based on the order of the reception of the edition commands, so that even if a client desiring to collaboratively edit the document file is additionally connected, the collaboratively edited document sharing apparatus 100 may provide the newest updated collaboratively edited document to the additional client 910 based on the stored edition command.

FIGS. 4A and 4B are diagrams illustrating an engine and an example of an output screen of a client sharing a collaboratively edited document by the method for sharing the collaboratively edited document according to the exemplary embodiment of the present disclosure.

Referring to FIG. 4A, each of the one or more clients 900 includes an engine 940. The engine 940 generates an updated collaboratively edited document based on a seed document file and an edition command. For example, when each of the one or more clients 900 collaboratively edits the document file based on the first seed document file 111, the engine 940 of each of the one or more clients 900 generates an updated collaboratively edited document by applying the received first edition command 131 to the first seed document file 111. That is, each of the one or more clients 900 may generate and output the updated collaboratively edited document based on the seed document file through the engine 940 whenever the edition command is received.

Referring to FIG. 4B, a collaboratively edited document output screen 400 is output on each of the one or more clients 900. Particularly, the collaboratively edited document output screen 400 may output the seed document file, and may also output the updated collaboratively edited document generated by applying the edition command to the seed document file. For example, a first collaboratively edited document output screen 401 outputs the first seed document file 111. Then, when each of the one or more clients 900 receives the first edition command 431, a second collaboratively edited document output screen 402 outputs the updated collaboratively edited document generated based on the first seed document file 111 and the first edition command 431 through the engine 940.

Accordingly, the edition commands transmitted from the command transferring server 120 are applied to the seed document file by the engine 940 of each of the one or more clients 900 so that each of the one or more clients 900 may generate the updated collaboratively edited document and output the updated collaboratively edited document, to which the edition commands transmitted in real time are applied.

The command transferring server 120 according to the exemplary embodiment of the present disclosure does not include an engine, which generates the updated collaboratively edited document by applying the edition command to the seed document file, and may transmit the edition command to the one or more clients 900 as soon as receiving the edition command. Accordingly, the collaboratively edited document sharing apparatus 100 may decrease resources and loads for the engine for generating the collaboratively edited document, and transmit the edition command to each of the one or more clients 900 in real time. That is, each of the one or more clients 900 may more rapidly output the collaboratively edited document through the collaboratively edited document sharing apparatus 100.

FIG. 5 is a diagram illustrating a relation between a configuration of an apparatus for sharing a collaboratively edited document and a client according to another exemplary embodiment of the present disclosure. FIG. 5 illustrates a process of generating a seed document file and transmitting the generated seed document file to a client, and an overlapping description of the constituent elements already described with reference to FIG. 3 will be omitted.

Referring to FIG. 5, any one of the one or more clients 900 uploads a document file on the sharing server 1000. When the sharing server 1000 receives a sharing signal, the sharing server 1000 may transmit the uploaded document file to the short cut file server 1200. Further, the sharing server 1000 may copy the uploaded document file and generate a seed document file, and transmit the seed document file to the seed document server 110. Accordingly, the seed document file is stored in the seed document server 110, and the short cut file server 1200 generates a short cut file based on the uploaded document file. Here, the short cut file includes information on a location, in which the seed document file is stored. Particularly, the short cut file may include information on an address of the seed document server 110, in which the seed document file generated based on the corresponding document file is stored, and information on a particular location within the seed document server 110, in which the seed document file is stored.

Referring to FIG. 5, each of the one or more clients 900 receives the seed document file from the seed document server 110 through the short cut file. Particularly, when the one or more clients 900 share the document file uploaded on the sharing server 1000, the one or more clients 900 do not directly share the uploaded document file and receives the seed document file through the short cut file. Accordingly, each of the one or more clients 900 collaboratively edits the document file based on the received seed document file, and transmits the edition command input for the collaborative edition to the command transferring server 120. A particular aspect of sharing, by the one or more clients 900, the seed document file through the short cut file will be described below with reference to FIG. 6.

The collaboratively edited document sharing apparatus 100 according to the exemplary embodiment of the present disclosure may store the seed document file for the collaborative edition and transmit the stored seed document file to the one or more clients 900, so that it is possible to store the document file for the collaborative edition, separately from the document file actually uploaded on the sharing server 1000. That is, the client uploading the document file may separate and manage the document file for the collaborative edition and a document file possessed personally.

FIGS. 6A and 6B are diagrams illustrating an example of an output screen of a client sharing a collaboratively edited document by the method for sharing the collaboratively edited document according to another exemplary embodiment of the present disclosure.

Referring to FIG. 6A, a collaboratively edited document output screen 610 displays a document file output from a predetermined client. Further, the collaboratively edited document output screen 610 displays a sharing button 611. Accordingly, a user of the predetermined client may transmit a sharing signal to the sharing server 1000 by clicking the sharing button 611 in the currently output document file.

Referring to FIG. 6B, a document file management screen 620 is a screen of an example of an application managing the document file output by the predetermined client. For example, the document file management screen 620 may be a screen of an example of a file manager capable of storing a document file and managing whether to share the document file. Here, the document file management screen 620 displays a sharing button 621, and displays a document file 631 and a short cut file 632. Further, the document file management screen 620 may further display a drop-down menu 622 while the drop-down menu 622 overlaps the document file 631 or the short cut file 632. Accordingly, a user of the predetermined client may transmit a sharing signal to the sharing server 1000 by clicking the sharing button 621 or selecting “share” in the drop-down menu 622 in the currently output document file.

Accordingly, the sharing server 1000 receiving the sharing signal transmits a signal so that the short cut file server 1200 generates a short cut file, and generates a seed document file and transmits the generated seed document file to the seed document server 110.

FIG. 7 is a diagram illustrating a relation between a configuration of an apparatus for sharing a collaboratively edited document and a client according to another exemplary embodiment of the present disclosure. FIG. 7 illustrates a process of transmitting an updated seed document file and an additional edition command to an additional client, and an overlapping description of the constituent elements already described with reference to FIGS. 3 and 5 will be omitted.

Referring to FIG. 7, when the additional client 910 is connected to the seed document server 110 so as to collaboratively edit the document file, the seed document server 110 transmits an updated seed document file to the additional client 910. Here, the additional client 910 may be a client requesting the collaborative edition of the document file from the seed document server 110 after each of the one or more clients 900 generates an updated collaboratively edited document based on the first seed document file 111 and one or more edition commands. Here, the additional client 910 may be a client which is not included in the client group 900. After the additional client 910 is connected to the collaboratively edited document sharing apparatus 100 to be described below and then generates an updated collaboratively edited document, the additional client 910 may be included in the client group 900.

Further, the seed document server 110 transmits the seed document file to the engine-pool server 140 according to a predetermined condition. For example, when the edition command is not received from the one or more clients 900 for a predetermined time, 200 or more edition commands are stored in the command storing server 130, or any one of the one or more clients 900 terminates the connection to the collaboratively edited document sharing apparatus 100, the seed document server 110 transmits the first seed document file 111 to the engine-pool server 140.

Further, the command storing server 130 transmits a command list 730 generated under a predetermined condition to the engine-pool server 140. Here, the command list 730 includes one or more edition commands. For example, the command list 730 may be generated while including the first edition command 131 and the second edition command 132.

Referring to FIG. 7, the command storing server 130 transmits the command list 730, which is generated based on one or more edition commands under the predetermined condition, to the engine-pool server 140. For example, when the edition command is not received from the one or more clients 900 for a predetermined time, 200 or more edition commands are stored in the command storing server 130, or any one of the one or more clients 900 terminates the connection to the collaboratively edited document sharing apparatus 100, the command storing server 130 may transmit the command list 730 to the engine-pool server 140.

Next, the engine-pool server 140 generates the updated seed document file based on the received seed document file and command list 730. For example, the engine-pool server 140 receives the first seed document file 111, receives the command list 730, and applies the first edition command 131 and the second edition command 132 to the first seed document file 111, thereby generating a second seed document file 112 that is the updated seed document file.

Next, the engine-pool server 140 transmits the generated updated seed document file to the seed document server 110, and the seed document server 110 stores the second seed document file 112 that is the updated seed document file together with the first seed document file 111. Accordingly, when the additional client 910 is connected, the seed document server 110 may transmit the updated seed document file to the additional client 910.

Referring to FIG. 7, the command storing server 130 transmits the additional edition command 133, which is stored after the command list 730 is transmitted to the engine-pool server 140, to the command transferring server 120. After the command list 730 is transmitted to the engine-pool server 140, the edition command received by the command storing server 130 becomes an additional edition command. For example, the third edition command 133 additionally received after the command list 730 is transmitted to the engine-pool server 140 becomes an additional edition command.

Referring to FIG. 7, the command transferring server 120 transmits the additional edition command 133 to the additional client 910. Particularly, when the additional client 910 is connected to the seed document server 110, the third edition command 133 that is the additional edition command is transmitted to the command transferring server 120, and the third edition command 133 that is the additional edition command is transmitted to the additional client 910 through the command transferring server 120.

That is, the additional client 910 may receive the updated seed document file from the seed document server 110, and receive only the additional edition command from the command transferring server 120 and generate the updated collaboratively edited document. The engine of generating the updated collaboratively edited document will be described below with reference to FIG. 8.

That is, the additional client 910 may transmit a collaborative edition request for the collaboratively edited document, which is being edited by the client group 900 including two or more clients, to the seed document server 110, receive the updated seed document file, which is generated based on one or more edition commands for editing the collaboratively edited document, which are received from the client included in the client group 900 before the engine pool-server 140 generates the updated seed document file, and the seed document from the seed document server 110, receive one or more additional edition commands for editing the collaboratively edited document, which are received from the client included in the client group after the updated seed document file is generated, from the command storing server 130, and generate the updated collaboratively edited document based on the updated seed document file received from the seed document server 110 and the additional edition command received from the command storing server 130.

When the additional client 910 receives the first seed document file 111, which has been already converted into the updated collaboratively edited document, the reception of both the first seed document file 111 and the one or more edition commands may be inefficient to collaboratively edit the document.

Accordingly, the collaboratively edited document sharing apparatus 100 stores the edition command as the command list 730 under the predetermined condition and generates the updated seed document file by using the engine-pool server 140, so that the additional client 910 may more efficiently and collaboratively edit the document file by receiving only the updated seed document file and the additional edition command.

Further, the command transferring server 120 may directly transfer the separate edition command or the additional edition command to the one or more clients 900 and the additional client 910 in real time, and the engine-pool server 140 may generate the updated seed document file based on only the seed document file and the command list 730, so that the collaboratively edited document sharing apparatus 100 allows the transfer of the command and the update of the seed document file to be performed in the dualized servers having different functions, thereby decreasing a processing load of each server and rapidly providing the file for the collaborative edition to the additional client 910. Accordingly, it is possible to more efficiently and rapidly edit the document file shared by many clients through the collaboratively edited document sharing apparatus 100.

FIGS. 8A and 8B are diagrams illustrating an engine and an example of an output screen of a client sharing a collaboratively edited document by the method for sharing the collaboratively edited document according to the still another exemplary embodiment of the present disclosure.

Referring to FIG. 8A, the additional client 910 also includes the engine 940. The engine 940 performs the same function as the engine 940 included in each of the one or more clients 900 as illustrated in FIG. 4A. Particularly, the engine 940 generates the updated collaboratively edited document based on the received updated seed document file 112 and additional edition command 133.

Referring to FIG. 8B, a collaboratively edited document output screen 800 is a screen output to the additional client 910, and outputs the updated collaboratively edited document. Particularly, the collaboratively edited document output screen 800 displays the updated collaboratively edited document including an indication 833, in which the additional edition command 133 is applied to the updated seed document file 112.

For example, when the additional edition command 133 is for deleting the line “God protect and preserve us”, the collaboratively edited document output screen 800 displays the updated collaboratively edited document including an indication to which the deletion is applied. FIG. 8B illustrates that the collaboratively edited document output screen 800 displays the updated collaboratively edited document, to which the deletion is applied, but depending on an exemplary embodiment, a part, to which the deletion is applied, may not be displayed, and may be displayed or may not be displayed on the collaboratively edited document output screen 800 according to a characteristic of the additional edition command 133.

The collaboratively edited document sharing apparatus 100 according to the exemplary embodiment of the present disclosure generates the updated seed document file through the engine-pool server 140, so that only the additional edition command is transmitted to the additional client 910 through the command transferring server 120, and thus the command transferring server 120 may not include an engine for updating the collaboratively edited document. Accordingly, the command transferring server 120 may not add an engine for updating the collaboratively edited document according to the addition of the client, and a processing load according to the increase in the number of engines is not increased. That is, the collaboratively edited document sharing apparatus 100 may decrease or minimize an engine for updating the collaboratively edited document, so that it is possible to efficiently, rapidly, and collaboratively edit the document even though the number of clients is increased.

Hereinafter, a method and an apparatus for sharing a collaborative document by using dualized servers according to a second exemplary embodiment of the present disclosure will be described. The exemplary embodiments described below may be independent from the aforementioned exemplary embodiments, and constituent elements included in the exemplary embodiments described below may perform different operations from those of the aforementioned exemplary embodiments.

Hereinafter, terms used for describing the second exemplary embodiment of the present disclosure will be defined.

A document editing terminal in the second exemplary embodiment of the present disclosure is a terminal capable of editing an electronic document file, and means a terminal capable of sharing an electronic document file stored in a sharing server, such as a cloud server, and editing contents, setting, and the like of the electronic document file.

A collaborative document in the second exemplary embodiment of the present disclosure is a collaboratively written document shared by a plurality of document editing terminals, and means an electronic document shared by the document editing terminals. The collaborative document may mean an electronic document stored in a cloud server which the document editing terminals access for sharing the electronic document.

A collaborative document file in the second exemplary embodiment of the present disclosure means a collaborative document itself, which may be shared and edited through a plurality of document editing terminals, or a path through which a plurality of document editing terminals may access a collaborative document. For example, the collaborative document file may be a collaborative document itself, which is transmitted to a sharing server, such as a cloud server, and is temporarily stored in a collaborative document sharing apparatus, or a link, through which a document editing terminal may access a collaborative document.

An edition command in the second exemplary embodiment of the present disclosure is a command for editing a collaborative document file shared by the document editing terminals, and may be generated by the document editing terminals editing the collaborative document file and may be transmitted to the apparatus for sharing the collaborative document. For example, the edition command may include a deletion command for deleting contents of the collaborative document file, an insertion command for inserting an object, such as a picture, and the like.

An edition command list in the second exemplary embodiment of the present disclosure is a list, in which the edition commands received from the command transferring server are stored based on an order of reception of the edition commands, and is a list, in which the edition commands received until an update condition is satisfied are stored.

An additional document editing terminal in the second exemplary embodiment of the present disclosure means a document editing terminal, which additionally requests a sharing of the collaborative document file from the sharing server after the document editing terminal shares the collaborative document file through the sharing server.

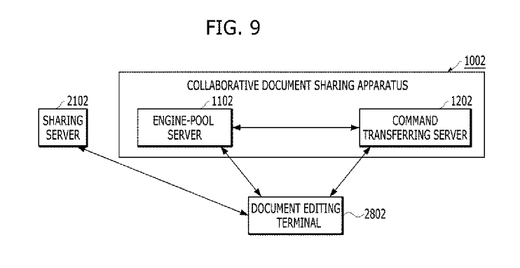

FIG. 9 is a diagram illustrating a schematic configuration of a collaborative document sharing apparatus, and a relation between the apparatus for sharing the collaborative document and a sharing server, and a relation between the apparatus for sharing the collaborative document and a document editing terminal according to the second exemplary embodiment of the present disclosure.

Referring to FIG. 9, a collaborative document sharing apparatus 1002 includes an engine-pool server 1102 and a command transferring server 1202.

The engine-pool server 1102 includes various kinds of engines, and particularly, various kinds of engines may be engines which are capable of executing or editing a collaborative document file. For example, the engine-pool server 1102 may include an engine receiving a collaborative document file, an engine executing a collaborative document file, an engine applying edited contents to a collaborative document file, or the like. Particularly, the engine-pool server 1102 includes an engine updating a collaborative document file.

The command transferring server 1202 includes a command received from a document editing terminal 2802. Particularly, the command transferring server 1202 receives an edition command editing the collaborative document file from the document editing terminal 2802. Further, the command transferring server 1202 stores the received edition command in an edition command list. Particularly, the command transferring server 1202 may temporarily store the edition command in the edition command list based on an order of the reception of the edition commands until an update condition for updating the collaborative document file is satisfied.

Referring to FIG. 9, the collaborative document sharing apparatus 1002 is connected with a sharing server 2102 and the document editing terminal 2802. Particularly, the collaborative document sharing apparatus 1002, the sharing server 2102, and the document editing terminal 2802 may be connected to be capable of communicating with each other, and may be connected so that the document editing terminal 2802 may share and edit the collaborative document file.

The sharing server 2102 is a server for storing a collaborative document file, and when the sharing server 2102 receives a sharing request for a collaborative document, the sharing server 2102 may provide the collaborative document file to at least one of the sharing server 2102 and the terminal editing terminal 2802. The sharing server 2102 may transmit the collaborative document file to the collaborative document sharing apparatus 1002, and receive and store an updated collaborative document file.

The document editing terminal 2802 may transmit a request for sharing the collaborative document file to the collaborative document sharing apparatus 1002 or the sharing server 2102, and receive and share the collaborative document file. Further, one document editing terminal 2802 is expressed for convenience of the description, but the document editing terminal 2802 may include two or more terminals sharing the collaborative document file.

The engine-pool server 1102 may be connected to be capable of communicating with the command transferring server 1202, and may receive the edition command list from the command transferring server 1202. That is, the collaborative document sharing apparatus 1002 is dualized into the engine-pool server 1102 including the collaborative document file and the updated collaborative document file, and the command transferring server 1202 transferring the edition command list to the engine-pool server 1102.

Accordingly, the collaborative document sharing apparatus 1002 including the dualized servers may improve waste of resources of the server, and deterioration of an update speed and performance of the collaborative document file, which are generated when the collaborative document file is updated whenever the edition command is received through one server.

Each configuration of the collaborative document sharing apparatus 1002 is separately illustrated for convenience of the description, and the configurations may be implemented by one configuration or one configuration may be divided into two or more configurations according to an implementation method.

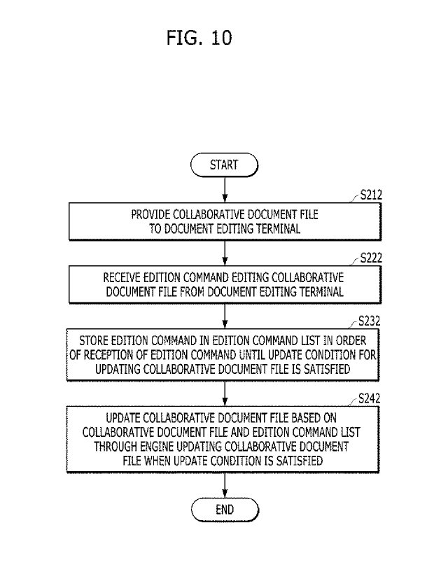

FIG. 10 is a flowchart illustrating a procedure for updating a collaborative document file according to a method for sharing a collaborative document by using the dualized servers according to the second exemplary embodiment of the present disclosure. For convenience of the description, the description is given with reference to FIG. 9.

A method for sharing a collaborative document by using the dualized servers according to the present disclosure is initiated by providing, the engine-pool server 1102, a collaborative document file to the document editing terminal 2802 (S212).

Particularly, the engine-pool server 1102 may receive a collaborative document file from the sharing server 2102, and provide the received collaborative document file to the document editing terminal 2802. That is, the engine-pool server 1102 may serve as a medium providing the collaborative document file stored in the sharing server 2102 to the document editing terminal 2802. Here, the collaborative document file within the engine-pool server 1102 may be transmitted from the sharing server 2102, which is separated from the engine-pool server 1102, and may be temporarily stored within the engine-pool server 1102.

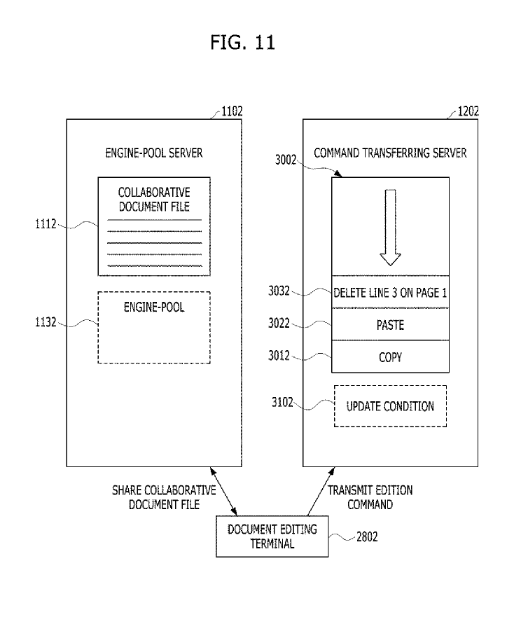

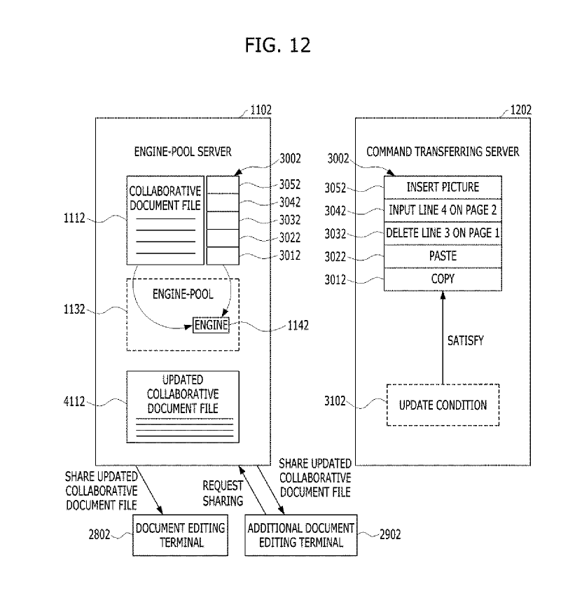

A process of providing, by the engine-pool server 1102, the collaborative document file before/after the update to the document editing terminal 2802 will be described with reference to FIGS. 11 and 12.

Next, the command transferring server 1202 receives an edition command editing the collaborative document file from the document editing terminal 2802 (S222). Next, the command transferring server 1202 stores the edition commands in the edition command list based on an order of the reception of the edition commands until an update condition for updating the collaborative document file is satisfied (S232).

Particularly, the command transferring server 1202 receives an edition command editing the collaborative document file from the document editing terminal 2802 sharing and editing the collaborative document file. Here, the command transferring server 1202 includes the edition command list. The edition command list may also be generated when the edition command arrives at the command transferring server 1202, and may also be generated in advance and stored in the command transferring server 1202.

Next, the command transferring server 1202 stores the edition commands in the edition command list based on an order of the arrival of the edition command to the command transferring server 1202. Particularly, the edition commands may be stored in the edition command list in a stack structure based on the order of the arrival of the edition commands to the command transferring server 1202. Further, the command transferring server 1202 may adjust the number of edition commands temporarily stored in the command transferring server 1202 including the update condition. Here, the update condition may also be directly set within the command transferring server 1202, and may also be transmitted to the command transferring server 1202 from the engine-pool server 1102 or the sharing server 2102 and stored in the command transferring server 1202. An example of the update condition will be described below with reference to FIG. 5.

Accordingly, the command transferring server 1202 receives the edition command from the document editing terminal 2802 and temporarily stores the edition command, and transmits the edition command list to the engine-pool server 1102, so that the command transferring server 1202 may temporarily store and transmit the edition command, thereby efficiently managing the edition command while being functionally separated from the engine-pool server 1102.

A process of receiving, by the command transferring server 1202, the edition command and transmitting the edition command list under the update condition will be described below with reference to FIGS. 3 and 4.

Next, when the update condition for updating the collaborative document file is satisfied, the engine-pool server 1102 updates the collaborative document file based on the collaborative document file and the edition command list through the engine updating the collaborative document file (S242).

Particularly, when the update condition for updating the collaborative document file is satisfied, the engine-pool server 1102 updates the collaborative document file through the engine within the engine-pool server 1102. Particularly, the engine-pool server 1102 may update the collaborative document file based on the edition command list and the collaborative document file through an idle engine within the engine-pool server 1102.

Accordingly, the engine-pool server 1102 may efficiently use the engine and improve an update speed of the collaborative document file by updating the collaborative document file through an idle engine, which is not operated, among the various engines within the engine-pool.

FIG. 11 is a diagram illustrating an example of a method of sharing a collaborative document file, and receiving and storing an edition command according to the method for sharing the collaborative document by using the dualized servers according to the second exemplary embodiment of the present disclosure.

Referring to FIG. 11, the engine-pool server 1102 includes a collaborative document file 1112 and an engine-pool 1132. Particularly, the engine-pool server 1102 temporarily stores the collaborative document file 1112 received from the sharing server 2102 while the document editing terminal 2802 shares and edits the collaborative document file 1112. Accordingly, the document editing terminal 2802 may share the collaborative document file through the engine-pool server 1102. Here, the engine-pool 1132 may include various engines, but the engine-pool server 1102 does not receive an edition command list 3002, so that the engine for updating the collaborative document file is not activated.

The command transferring server 1202 includes the edition command list 3002 and an update condition 3102. Particularly, the command transferring server 1202 receives an edition command editing the collaborative document file from the document editing terminal 2802, and stores the edition command in the edition command list 3002 based on an order of the reception of the edition command. That is, the edition command list 3002 stores a first edition command 3012, which first arrives at the command transferring server 1202, at the lowermost end of the edition command list 3002, and then stores a second edition command 3022 on the first edition command 3012 and stores a third edition command 3032 on the second edition command 3022 according to an order of the arrival of the edition commands to the command transferring server 1202. For example, the edition command list 3002 has a stack structure, in the edition command list 3002, “copy” that is the first edition command 3012 first arrives at the command transferring server 1202, “paste” that is the second edition command 3022 arrives at the command transferring server 1202 next to the first edition command 3012, and “delete the third line on page 1” that is the third edition command 3032 arrives at the command transferring server 1202 next to the second edition command 3022.

Accordingly, the sharing of the collaborative document file is executed through the engine-pool server 1102, and the storage of the edition command is executed through the command transferring server 1202, so that the document editing terminal 2802 may transfer the edition command while efficiently sharing the collaborative document file through the dualized servers.

FIG. 12 is a diagram illustrating an example of a method of sharing a collaborative document with an additional document editing terminal according to the method for sharing the collaborative document by using the dualized server according to the second exemplary embodiment of the present disclosure. FIG. 12 illustrates a process of updating the collaborative document file 1112 when the update condition is satisfied, and an overlapping description of the constituent elements already described with reference to FIG. 11 will be omitted.

Referring to FIG. 12, when the update condition 3102 is satisfied, the command transferring server 1202 transmits the edition command list 3002 to the engine-pool server 1102. For example, when the update condition 3102 is “reception of five edition commands”, the command transferring server 1202 may transmit the edition command list 3002 to the engine-pool server 1102 at a moment at which the first edition command 3012 to the fifth edition commands 3052 are stored in the edition command list 3002.

Accordingly, the engine-pool server 1102 may receive the edition command list 3002, and update the collaborative document file 1112 based on the collaborative document file 1112 and the edition command list 3002 through an engine 1142 within the engine-pool 1132. Particularly, when the edition command list 3002 arrives at the engine-pool server 1102, the engine 1142 may generate an updated collaborative document file 4112 based on the collaborative document file 1112 and the edition command list 3002. Here, the engine 1142 may be an engine randomly selected from idle engines which are not used within the engine-pool 1132.

Next, the engine-pool server 1102 transmits the updated collaborative document file 4112 to the document editing terminal 2802. That is, the engine-pool server 1102 may transmit the updated collaborative document file 4112 to the document editing terminal 2802 at a moment at which the updated collaborative document file 4112 is generated through the engine 1142 by receiving the edition command list 3002 transmitted according to the satisfaction of the update condition.

Further, when the number of document editing terminals requesting the sharing of the collaborative document file 1112 is increased, the engine-pool server 1102 may transmit the updated collaborative document file 4112 to an additional document editing terminal 2902 additionally connected to the engine-pool server 1102. That is, the engine-pool server 1102 may immediately provide the updated collaborative document file 4112 to the additional document editing terminal 2902, which additionally requests the sharing of the collaborative document file 1112 after the updated collaborative document file 4112 is generated, without a need for sharing the collaborative document file 1112 before the update.

Accordingly, the additional document editing terminal 2902 may rapidly share the updated collaborative document file 4112, to which the most recently edited contents are reflected, from a time, at which the sharing of the collaborative document file is requested.

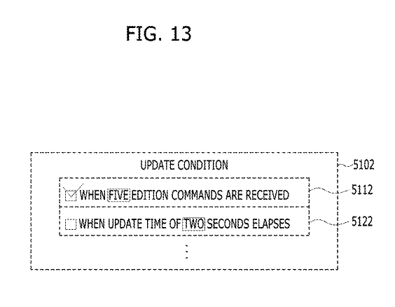

FIG. 13 is a diagram illustrating an example of an update condition selectable in the method for sharing the collaborative document by using the dualized servers according to the second exemplary embodiment of the present disclosure.

Referring to FIG. 13, an update condition list 5102 may include various update conditions. Particularly, the update condition list 5102 may be a case where a size of the edition command list 3002 is equal to or larger than a predetermined stack size, or a case where a predetermined update time for updating the collaborative document file elapses. For example, the update condition list 5102 may include a plurality of update conditions, and may include a first update condition 5112 that is when five edition commands are received“, a second update condition 5122 that is when an update time of two seconds elapses”, and the like.

Only one update condition may also be selected in the update condition list 5102. Further, each update condition may be particularly set or changed by a user setting the update condition. For example, in the update condition list 5102, only a first update condition 5112 may also be selected, and the number of received edition commands in the first update condition 5112 may also be set to “5” by the user.

Accordingly, the update condition may be particularly set or freely changed by the user, and depending on a case, the collaborative document sharing apparatus 1002 may efficiently share and edit the collaborative document file by changing the update condition and rapidly share the updated collaborative document file.

In the present specification, each block or each operation may represent a part of modules, segments, or codes including one or more executable instructions for executing specific logical functions. Further, it shall be noted that in several replaced exemplary embodiments, functions mentioned in the blocks or the operations may be generated without an order. For example, the subsequently illustrated two blocks or operations may be substantially simultaneously performed in actual, or the blocks or the operations may be sometimes performed in a reverse order according to a corresponding function.

Steps of the method or the algorithm described in relation to the exemplary embodiments disclosed in the present specification may also be directly implemented by a hardware module or a software module executed by a processor, or a combination of the hardware module and the software module. The software module may reside in a RAM memory, a flash memory, a ROM memory, an EPROM memory, an EEPROM memory, a register, a hard disk, a detachable disk, a CD-ROM, or another type of random storage media known in the art. An example of a storage medium is coupled to a processor, and the processor may read information from the storage medium and write information in the storage medium. As another method, the storage medium may be integral with the processor. The processor and the storage medium may reside within an application specific integrated circuit (ASIC). The ASIC may reside within a user terminal. As another method, the processor and the storage medium may reside within the user terminal as a separate component.

The exemplary embodiments of the present disclosure have been described in more detail with reference to the accompanying drawings, but the present disclosure is not essentially limited to the exemplary embodiments, and may be variously modified and carried out without departing from the scope of the technical spirit of the present disclosure. Accordingly, the exemplary embodiments disclosed herein are not intended to limit the technical spirit but describe the technical spirit of the present disclosure, and the scope of the technical spirit of the present disclosure is not limited by the exemplary embodiment. Therefore, it shall be understood that the aforementioned exemplary embodiments are illustrative in all aspects and are not limited. The scope of the present disclosure should be construed based on the following appended claims and it should be construed that the technical spirit included within the scope equivalent to the claims belongs to the scope of the right of the present disclosure.

### MODE FOR CARRYING OUT THE INVENTION

From the foregoing, relevant contents have been described in the best mode for carrying out the invention.

### INDUSTRIAL APPLICABILITY

The present disclosure is usable in a digital device for collaboratively editing a document through a network and the like.

1. An apparatus for sharing a collaboratively edited document, the apparatus comprising:
a command transferring server configured to receive two or more edition commands related to a collaboratively edited document from one or more clients included in a client group including two or more clients, and transmit the two or more edition commands to each of the clients included in the client group based on an order of the reception of the edition commands; and
an engine-pool server configured to, when a predetermined condition is satisfied, update a seed document file related to the collaboratively edited document based on a command list collected based on the order of the reception of the received edition commands.

2. The apparatus of claim 1, further comprising:
a command storing server configured to generate the command list collected based on the order of the reception of the received edition commands, and transmit the command list to the engine-pool server when the predetermined condition is satisfied.

3. The apparatus of claim 2, wherein the predetermined condition includes a case where the edition command is not received from the one or more clients for a predetermined time, a case where the edition command is accumulated in the command storing server to be larger than a predetermined threshold value, or a case where a connection termination of one or more clients is detected.

4. The apparatus of claim 1, further comprising:
a seed document server configured to store a seed document file generated based on a document file uploaded on a sharing server, and transmit the seed document file to one or more clients included in the client group including two or more clients.

5. The apparatus of claim 4, wherein the engine-pool server transmits an updated seed document file to the seed document server, and
the seed document server stores the updated seed document file together with the seed document file.

6. The apparatus of claim 5, wherein when an additional client, which is not included in the client group, is connected to the seed document server so as to collaboratively edit the document file,
the seed document server transmits the updated seed document file to the additional client,
the command storing server transmits an additional edition command, which is stored after the command list is transmitted to the engine-pool server, to the command transferring server, and
the command transferring server transmits the additional edition command to the additional client.

7. The apparatus of claim 1, further comprising:
a short cut file server configured to generate a short cut file based on the document file when a sharing server receives a sharing signal indicating a desire to share the document file with a client included in the client group or an additional client which is not included in the client group.

8. The apparatus of claim 7, wherein the short cut file includes information on a location, in which the seed document file is stored, and
the seed document server enables each of the one or more clients included in the client group or an additional client to receive the seed document file through the short cut file.

9. A method of sharing a collaboratively edited document, which is performed by an apparatus of sharing a collaboratively edited document, the method comprising:
transmitting, by a seed document server, a seed document file to one or more clients included in a client group including two or more clients;
receiving, by a command transferring server, two or more edition commands related to a collaboratively edited document from the one or more clients;
transmitting, by the command transferring server, the two or more edition commands to each of the clients included in the client group based on an order of the reception of the two or more edition commands; and
when a predetermined condition is satisfied, updating, by an engine-pool server, a seed document file related to the collaboratively edited document based on a command list collected based on the order of the reception of the received edition commands, and generating an updated seed document file.

10. The method of claim 9, further comprising:
generating, by the command storing server, the command list collected based on the order of the reception of the received edition commands; and
transmitting, by the command storing server, the command list to the engine-pool server when the predetermined condition is satisfied.

11. The method of claim 9, further comprising:
when an additional client, which is not included in the client group, is connected so as to collaboratively edit the document file, transmitting, by the seed document server, the updated seed document file to the additional client; and
transmitting, by the command transferring server, an additional edition command, which is stored after the updated seed document file is generated, to the additional client.

12. The method of claim 9, further comprising:
transmitting, by the seed document server, the seed document file to each of the one or more clients included in the client group or an additional client connected through a short cut file generated based on the document file.

13. A computer-readable recording medium, which is executable in a computer and includes a plurality of commands executed by one or more processors, the computer-readable recording medium comprising:
a command for transmitting, by a seed document server, a seed document file to one or more clients included in a client group including two or more clients;
a command for receiving, by a command transferring server, two or more edition commands related to a collaboratively edited document from the one or more clients;
a command for transmitting, by the command transferring server, the two or more edition commands to each of the clients included in the client group based on an order of the reception of the two or more edition commands; and
a command for updating, by an engine-pool server, a seed document file related to the collaboratively edited document based on a command list collected based on the order of the reception of the received edition commands, and generating an updated seed document file when a predetermined condition is satisfied.

14. A method of sharing a collaboratively edited document, which is performed by a client device, the method comprising:
transmitting an edition command editing a collaboratively edited document to a command transferring server so that the edition command is transferred to one or more other clients included in a client group including two or more clients through the command transferring server;
receiving an edition command editing a collaboratively edited document, which is transmitted from the command transferring server and represents an edition for the collaboratively edited document performed by another client; and
generating an updated collaboratively edited document based on the edition command editing the collaboratively edited document received from the one or more other clients and the collaboratively edited document.

15. A method of sharing a collaboratively edited document, which is performed by a client device, the method comprising:
transmitting a request for a collaborative edition for a collaboratively edited document, which is currently edited by a client group including two or more clients, to a seed document server;
receiving an updated seed document file generated based on one or more edition commands editing a collaboratively edited document, which are received from the client included in the client group before an engine-pool server generates the updated collaboratively seed document file, and a seed document from the seed document server;
receiving one or more additional edition commands editing the collaboratively edited document, which are received after the updated seed document file is generated from the client included in the client group, from a command storing server; and
generating an updated collaboratively edited document based on the updated seed document file received from the seed document server and the additional edition command received from the command storing server.
